(19) United States
(12) Patent Application Publication
(10) Pub. No.: US 2018/0345363 A1
(43) Pub. Date: Dec. 6, 2018

(54) INTERLOCKING REFRACTORY GATING SYSTEM FOR STEEL CASTING

(71) Applicant: Schaefer Industries, Inc., Allentown, PA (US)

(72) Inventors: Richard E. Kilgore, Allentown, PA (US); Nicholas Schaefer, Allentown, PA (US)

(21) Appl. No.: 15/615,256

(22) Filed: Jun. 6, 2017

(51) Int. Cl. B22D 27/04; B29C 33/30; B22D 17/30

(52) U.S. Cl. CPC B22D 27/04; B29C 33/0077; B22D 17/30; B29C 33/302

(57) ABSTRACT

A customizable gating system for metal casting that includes a duct assembly formed from refractory conduit components is disclosed. The gating system is configured to deliver molten metal to a gateway for a mold. The duct assembly is formed from refractory conduit components that can withstand the high temperatures of molten metal and include advantageous features for forming the components, for adjusting the length of conduit components as needed to provide a customized duct assembly, and for interconnecting components to form a duct assembly.

### BACKGROUND

Ceramic gating systems are known for enabling the transfer of molten metal to a mold for metal casting. Such gating systems are useful because they are refractory (i.e., resistant to high heat) and can withstand the erosive and corrosive environment associated with contacting flowing molten metal. In order to create a pathway for molten metal to travel, it is known to use a series of ceramic tubes and connectors to form a conduit network that enables the smooth transfer of molten metal from a furnace to a mold.

Gating systems are made from tubes and connectors that are embedded in granulated mediums, such as sand, and form the pathway through which molten metal flows within a mold during the casting process. The granulated medium is compacted and surrounds the entire gating system, holding the parts in place via compression and preventing their movement during the casting process. In such circumstances, the tubes and connectors are typically assembled prior to being embedded in the granulated medium, and once the desired system's architecture is created, the granulated medium is poured into the enclosed space (i.e., a mold box), surrounding the gating system's assembled parts. Such gating systems need a mechanism by which the various tubes and connectors are initially held in place so that they maintain their structure and orientation during the introduction of the granulated medium.

Many such gating systems utilize butt joints or friction fits to connect the tubes and connectors, sometimes requiring an adhesive to hold such parts together. However, these connections between the various tubes and connectors are weak by themselves and may not hold during movement of the system or the introduction of the granulated medium, allowing the granulated medium to enter the gating system and/or the gating components to separate during compaction.

Therefore, there is a need for a gating system that has connections between the parts of the system that inhibit separation, allowing for easy assembly and tightness of fit.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosed embodiments satisfy the need in the art by providing a customizable gating system for metal casting that includes a duct assembly formed from refractory conduit components. The gating system is configured to deliver molten metal to a gateway for a mold. The duct assembly is formed from refractory conduit components that can withstand the high temperatures of molten metal and include advantageous features for forming the components, for adjusting the length of conduit components as needed to provide a customized duct assembly, for interconnecting components to form a duct assembly, and to assure a smooth and laminar flow of metal to the mold

The disclosed refractory components are formed as two-part assemblies. Forming the components from two-part assemblies enables the parts to be formed via press-molding which provides high surface quality, unitary and relatively high density ceramic or ceramic-composite components that lack any inserts or assembly attachments embedded therein. Through the use of multi-part assemblies, design features such as radii can be added and/or enhanced to the gating system to aid in laminar flow of the molten metal, reducing air entrapment that can cause defects in finished castings. Higher surface quality components ensure fewer ceramic inclusions that can result from loose and/or friable material washing into molten metal traveling through the components and can also help to improve laminar flow. Press-molding enables tighter dimensional tolerances for a better and more consistent fit, tighter fit between parts of the system, which helps maintain laminar flow through the entire gating system.

In particular, the present disclosure relates to a conduit connector component for creating a customizable duct assembly. The conduit connector component includes a base having four walls and a mating surface adjacent to the four walls, a conduit channel extending from the mating surface into the base and defining a conduit channel surface that extends between a first channel rim and a second channel rim, a tube-fitting recess formed in the base that is coaxially aligned with the conduit channel, a locking channel formed in the base that is coaxially aligned with said tube-fitting recess. The locking channel is sized and shaped to receive a locking tab from a tube for securing the tube in the tube-fitting recess. The mating surface is sized and shaped to interface with a mating surface of a second identical conduit connector component such that when the two components are attached via their respective mating surfaces, an enclosed conduit connector is created.

The present disclosure also relates to a tube component for creating a customizable duct assembly. The tube component includes an elongated semi-cylindrical tube base having a first end, a second end, an outer surface, and an inner surface. The tube component also includes a first mating surface extending between the outer surface and the inner surface on one side of the tube base and a second mating surface extending between the outer surface and the inner surface on an opposing side of the tube base. The tube base includes a first locking tab and a second locking tab disposed on said outer surface and located on either end of the tube base, and a plurality of intermediate locking tabs disposed on the outer surface between the first and second locking tabs. Each of the locking tabs being sized and shaped to interface and engage with a locking channel of a tube-fitting recess of a conduit connector.

### BRIEF DESCRIPTION OF DRAWINGS

The interlocking refractory gating for steel casting according to the present invention is further described with reference to the accompanying drawings, in which:

FIG. 1 is a perspective view of a gating system for metal casting constructed using refractory conduit components constructed in accordance with an embodiment of the present invention;

FIG. 2A is a perspective view of a refractory conduit component constructed in accordance with an embodiment of the present invention, the component having the shape of a cross-connector;

FIG. 2B is a perspective view of a refractory conduit component constructed in accordance with an embodiment of the present invention, the component having the shape of an elbow connector;

FIG. 2C is a perspective view of a refractory conduit component constructed in accordance with an embodiment of the present invention, the component having the shape of a linear connector;

FIG. 2D is a perspective view of a refractory conduit component constructed in accordance with an embodiment of the present invention, the component having the shape of a tee junction;

FIG. 3 is a perspective view of a refractory conduit component constructed in accordance with an embodiment of the present invention, the component having the shape of a tube;

FIG. 4 is a front elevational view of the tube component shown in FIG. 3;

FIG. 5 is a front elevational view of a refractory conduit tube created using two interfacing tube components constructed in accordance with the embodiment shown in FIG. 3; and

FIG. 6 is a schematic view of an elbow connector being fitted with two conduit tubes in accordance with an embodiment of the present invention, the elbow connector being built from refractory conduit components constructed in accordance with the embodiment shown in FIG. 2B and the tubes being built from refractory conduit components constructed in accordance with the embodiment shown in FIG. 3.

### DETAILED DESCRIPTION

The ensuing detailed description provides preferred exemplary embodiments only, and is not intended to limit the scope, applicability, or configuration of the herein disclosed inventions. Rather, the ensuing detailed description of the preferred exemplary embodiments will provide those skilled in the art with an enabling description for implementing the preferred exemplary embodiments in accordance with the herein disclosed invention. It is understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification, in order to provide context for other features.

Reference numerals that are introduced in the specification in association with a drawing figure may be repeated in one or more subsequent figures without additional description in the specification in order to provide context for other features.

In the claims, letters are used to identify claimed steps (e.g. (a), (b), and (c)). These letters are used to aid in referring to the method steps and are not intended to indicate the order in which claimed steps are performed, unless and only to the extent that such order is specifically recited in the claims.

The articles “a” and “an”, as used herein and unless otherwise indicated, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

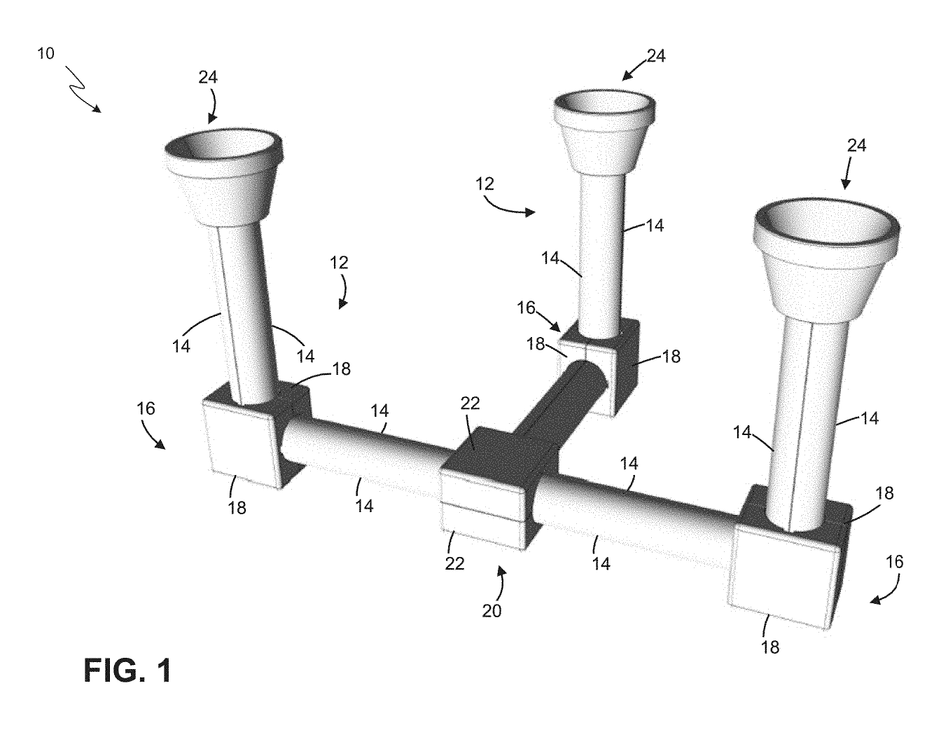

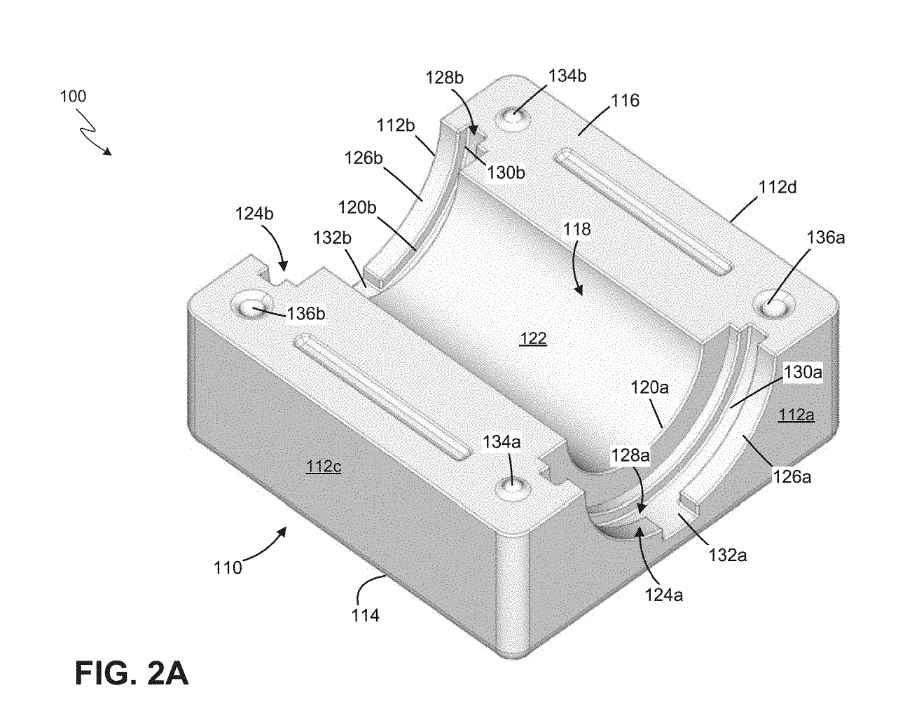

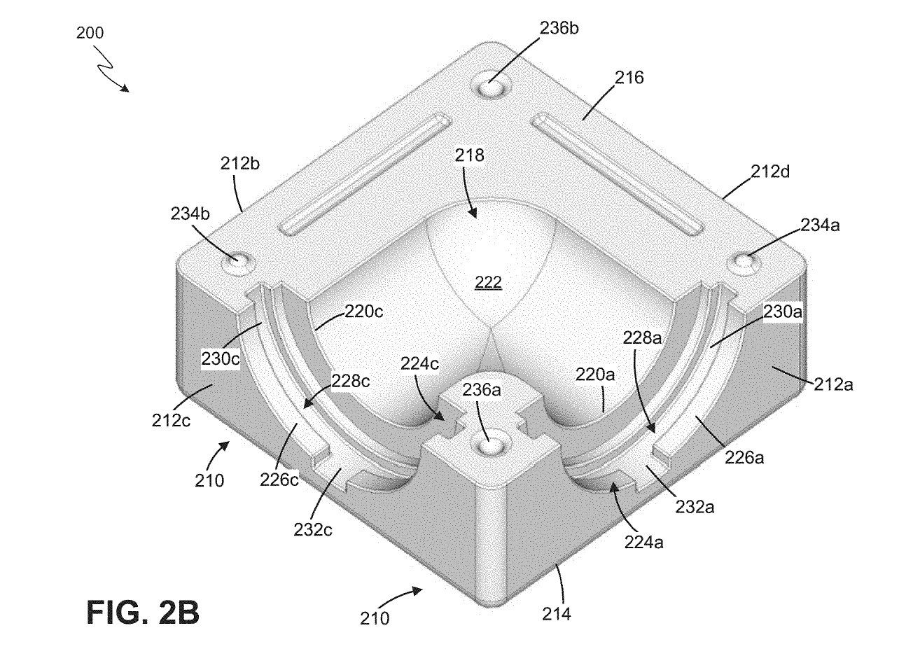

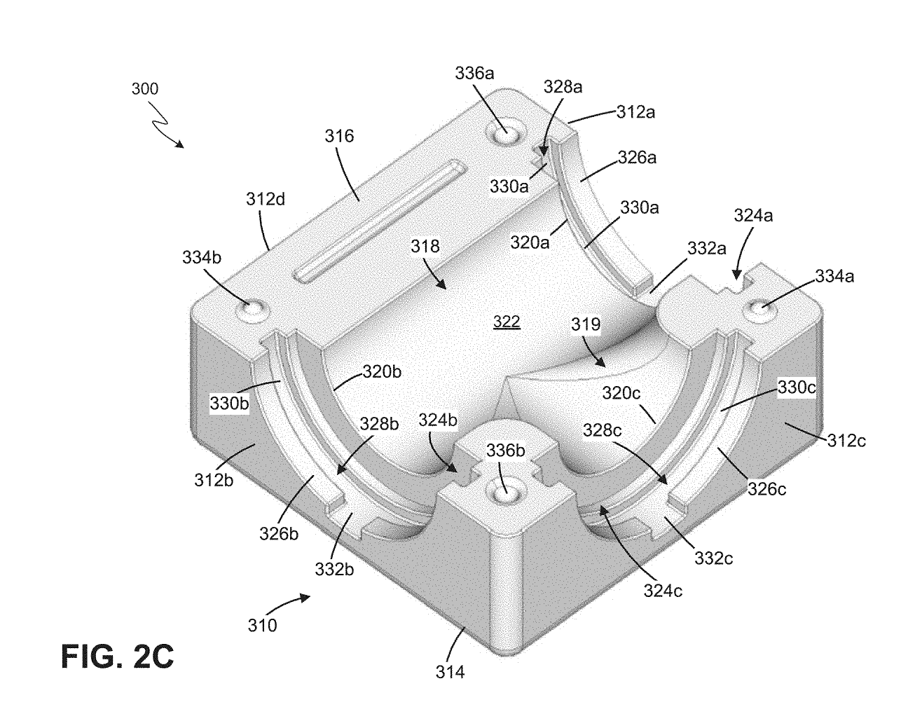

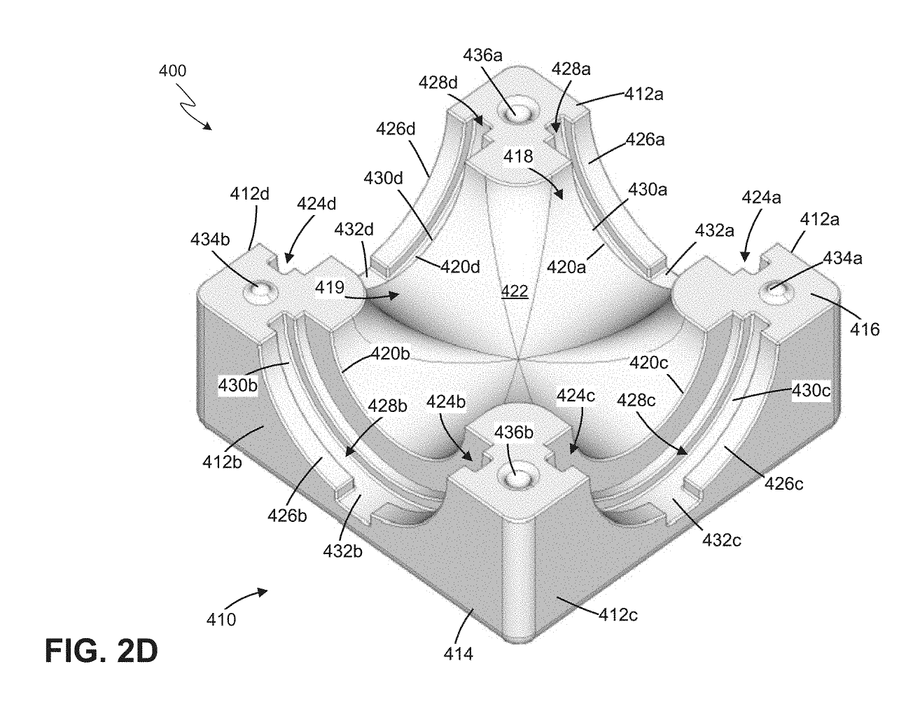

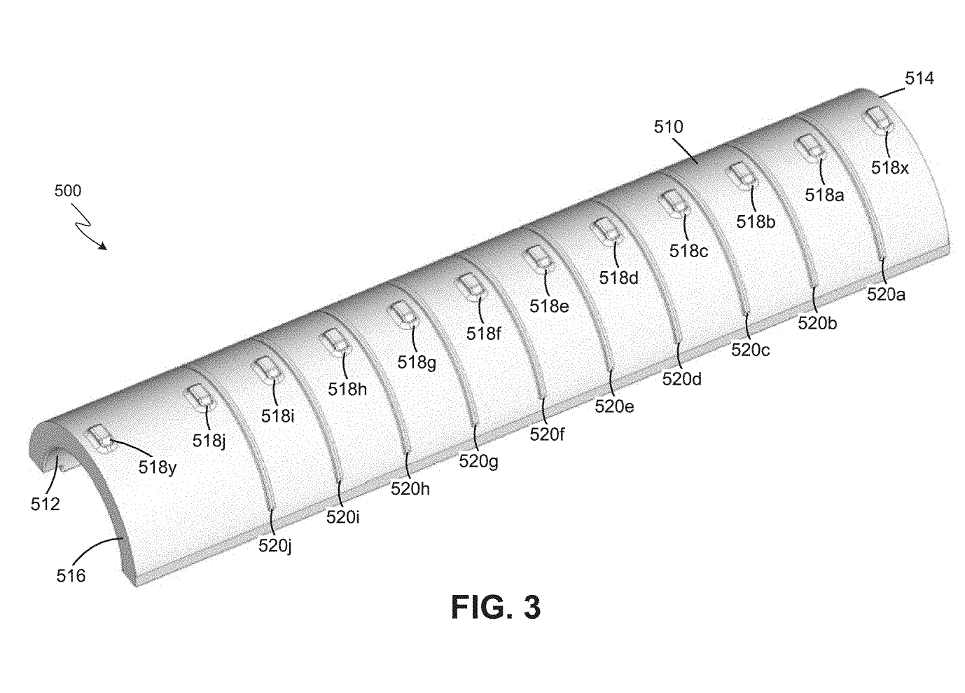

Turning now to the figures, FIG. 1 illustrates a duct assembly 10 for metal casting formed from refractory conduit components constructed in accordance with an embodiment of the present invention. More particularly, the duct assembly 10 includes a plurality of tubes 12 made from interfacing tube components 14, a plurality of elbow junction 16 made from interfacing elbow junction components 18, a tee junction 20 made from interfacing tee junction components 22, and funnels 24 which may or may not be made from interfacing funnel components (not shown). The tube components 14, elbow junction components 18, and tee junction components 22, along with linear connector components and cross-connector components, are shown in FIGS. 2A, 2B, 2C, 2D, and 3 and are discussed in detail further below. These refractory conduit components are made from materials that that can withstand high temperatures, such as that of molten metal. Such materials include, but are not limited to, ceramic.

Turning now to FIG. 2A, a linear connector component 100 is shown having a solid base 110 with a first wall 112a, a second wall 112b opposite the first wall 112a, a third wall 112c extending between the first and second walls 112a, 112b, and a fourth wall 112d also extending between the first and second walls 112a, 112b and opposite the third wall 112c. The base 110 also has a bottom outer surface 114 and an upper mating surface 116 opposite the bottom outer surface 114, with a conduit channel 118 extending from the upper mating surface 116 into the base 110 toward the bottom outer surface 114. The conduit channel 118 is semi-cylindrical in shape and has a first semi-annular rim 120a located proximate to the first wall 112a, a second semi-annular rim 120b located proximate to the second wall 112b, and a conduit channel surface 122 extending between the first semi-annular rim 120a and the second semi-annular rim 120b. The conduit channel surface 122 is smooth to reduce turbulence in any fluid, such as molten metal, traveling through the conduit channel 118.

Still referring to FIG. 2A, the linear connector component 100 includes a first tube-fitting recess 124a and a second tube-fitting recess 124b that are coaxially aligned with the conduit channel 118. The first tube-fitting recess 124a extends from the first wall 112a to the first semi-annular rim 120a and extending radially into the base 110 from the first semi-annular rim 120a toward the bottom outer surface 114, creating a first tube-fitting surface 126a. Likewise, the second tube-fitting recess 124b extends from the second wall 112b to the second semi-annular rim 120b and extending radially into the base 110 from the second semi-annular rim 120b toward the bottom outer surface 114, creating a second tube-fitting surface 126b. The first and second tube-fitting recesses 124a, 124b are sized and shaped to engage with a tube 12 such that the outer surface of the tube 12 is adjacent to either the first tube-fitting surface 126a or the second tube-fitting surface 126b. Similarly, the conduit channel surface 122 is sized and shaped such that when a tube 12 engages with either the first or second tube-fitting recesses 124a, 124b, the interior surface of the tube 12 is in alignment with the conduit channel surface 122.

Each of the first and second tube-fitting recesses 124a, 124b includes a locking channel (i.e., first and second locking channels 128a, 128b) that extends radially outwardly from the tube-fitting surface (i.e., first and second tube-fitting surfaces 126a, 126b) into the base 110 toward the bottom outer surface 114, creating a locking channel surface (i.e., first and second locking channel surfaces 130a, 130b). Each of the first and second tube-fitting recesses 124a, 124b also includes a slot (i.e., first and second slots 132a, 132b) that extends laterally from the locking channel surface (i.e., first and second locking channel surfaces 130a, 130b) to its most proximate wall (i.e., first and second walls 112a, 112b) and depthwise from the tube-fitting channel surface (i.e., first and second tube-fitting surfaces 126a, 126b) into the base 110. The first and second locking channels 128a, 128b and the first and second slots 132a, 132b are sized and shaped to accommodate a locking tab from a tube 12 in the manner discussed further below.

Still referring to FIG. 2A, the upper mating surface 116 includes a number of protrusions 134a, 134b extending outwardly from the upper mating surface 116 and away from the base 110, and a number of cavities 136a, 136b extending inwardly from the upper mating surface 116 and toward the base 110. The protrusions 134a, 134b and cavities 136a, 136b of the linear connector component 100 are positioned on the upper mating surface 116 in such a manner that when the mating surfaces 116 of two identical linear connector components 100 meet, each of the protrusions 134a, 134b interfaces with a corresponding one of the cavities 136a, 136b, creating a lateral friction fit between the two identical linear connector components 100. This friction fit can be further enhanced or secured by using an adhesive between the two mating surfaces 116, thereby securing the two linear connector components 100 together to form a linear connector (not shown).

FIG. 2B illustrates an elbow connector component 200, which corresponds to the elbow junction components 18 from the assembly 10 shown in FIG. 1. The elbow connector component 200 is constructed in a similar manner to that of the linear connector component 100 shown in FIG. 2A, and the elements illustrated in FIG. 2B which correspond to the elements described above in reference to FIG. 2A have been designated by corresponding reference numerals increased by one hundred. What makes the elbow connector component 200 different from the linear connector component 100 is that the conduit channel 218 has an elbow joint shape, leading the second tube-fitting recess 224c and its associated features (i.e., the second tube-fitting surface 226c, second locking channel 228c, second locking channel surface 230c, and second slot 232c) appear on a wall adjacent to the first wall 212a (i.e., third wall 212c), rather than the opposing wall.

FIG. 2C illustrates a tee junction component 300, which corresponds to the tee junction components 22 from the assembly 10 shown in FIG. 1. The tee junction component 300 is constructed in a similar manner to that of the linear connector component 100 shown in FIG. 2A, and the elements illustrated in FIG. 2C which correspond to the elements described above in reference to FIG. 2A have been designated by corresponding reference numerals increased by two hundred. What makes the tee junction component 300 different from the linear connector component 100 is an additional conduit channel 319 that intersects perpendicularly with the conduit channel 318 to form a T-shaped channel. This additional conduit channel 319 is associated with a third tube-fitting recess 324c that extends from the third wall 312c to the third semi-annular rim 320c and includes identical features as those associated with the first and second tube-fitting recesses 324a, 324b (i.e., a third tube-fitting surface 326c, third locking channel 328c, third locking channel surface 330c, and third slot 332c).

FIG. 2D illustrates a cross-connector component 400 that is constructed in a similar manner to that of the linear connector component 100 shown in FIG. 2A. The elements illustrated in FIG. 2D which correspond to the elements described above in reference to FIG. 2A have been designated by corresponding reference numerals increased by three hundred. What makes the cross-connector component 400 different from the linear connector component 100 is an additional conduit channel 419 that intersects and extends through the conduit channel 418 to form two orthogonal crossing channels. This additional conduit channel 419 is associated with a third tube-fitting recess 424c that extends from the third wall 412c to the third semi-annular rim 420c and a fourth tube-fitting recess 424d that extends from the fourth wall 412d to the fourth semi-annular rim 420d. Both the third and fourth tube-fitting recesses 424c, 424d include identical features as those associated with the first and second tube-fitting recesses 424a, 424b (i.e., third and fourth tube-fitting surfaces 426c, 426d, third and fourth locking channels 428c, 428d, third and fourth locking channel surfaces 430c, 430d, and third and fourth slots 432c, 432d).

Turning now to FIG. 3, a tube component 500 is shown having an outer surface 510 that is semi-cylindrical in shape, an inner surface 512 that is also semi-cylindrical in shape, a front end 514, and a back end 516. In one embodiment, the outer surface 510 has a first locking tab 518x located proximal to the front end 514 of the tube component 500 and a second locking tab 518y located proximal to the back end 516 of the tube component 500. The first locking tab 518x is sized, shaped, and oriented on the outer surface 510 proximal to the front end 514 such that when the front end 514 of the tube component 500 engages with a tube-fitting recess of any one of the connector components discussed above (e.g., first tube-fitting recess 124a of the linear connector component 100 shown in FIG. 2A), the first locking tab 518x is able to fit through the slot of the tube-fitting recess (e.g., slot 132a) and slidably engage with the associated locking channel (e.g., locking channel 128a). The second locking tab 518y is similarly sized, shaped, and oriented on the outer surface 510 proximal to the back end 516.

In another embodiment, a plurality of intermediate locking tabs 518a-j are disposed on the outer surface 510 of the tube component 500 along with a plurality of semi-annular scores or grooves 520a-j formed in the outer surface 510, with each of the locking tabs 518a-j being proximately located to a corresponding one of the semi-annular grooves 520a-j. The plurality of semi-annular grooves 520a-j are potential locations for a user to cut and shorten the tube component 500, leaving its corresponding one of the intermediate locking tabs 518a-j as the tab for engaging with a locking grove of a tube-fitting recess, as will be discussed further below. Therefore, unlike the prior art, the tube component 500 of this embodiment retains its ability to interlock with a cross-connector component 400 even after being cut to length.

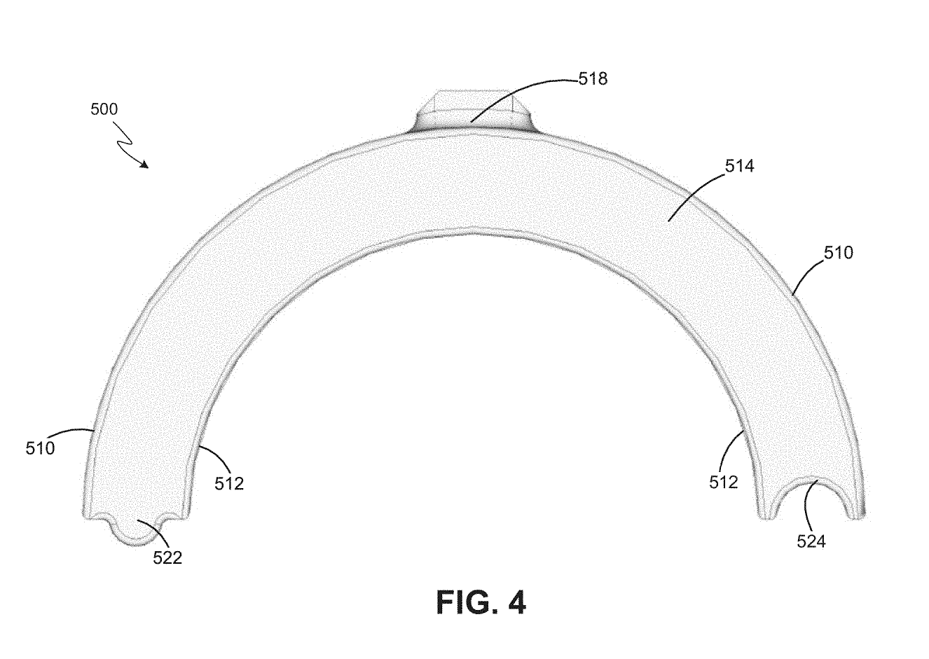

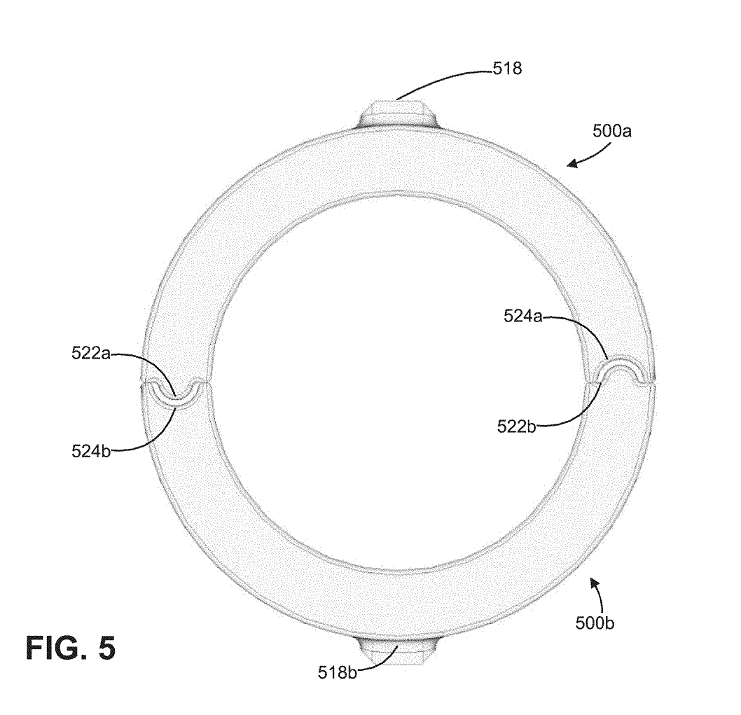

Referring now to FIGS. 4 and 5, the tube component 500 includes a first mating surface 522 and a second mating surface 524. The first mating surface 522 extends between the front end 514 and the back end 516 and between the outer surface 510 and the inner surface 512 on one side, and the second mating surface 524 extends between the front end 514 and the back end 516 and between the outer surface 510 and the inner surface 512 on the opposing side. The first mating surface 522 and second mating surface 524 are sized and shaped to interface such that, as seen in FIG. 5, when two identical tube components 500a, 500b are mated, the first mating surface 522a of the first tube component 500a connects with the second mating surface 524b of the second tube component 500b, and the second mating surface 524a of the first tube component 500a connects with the first mating surface 522b of the second tube component 500b. This connection between the mating surfaces of the first and second tube components 500a, 500b can be enhanced using adhesive to ensure that the first and second tube components 500a, 500b do not separate when in use. Referring back to FIG. 4, in one embodiment, the first mating surface 522 includes a tongue shape and the second mating surface 524 includes a groove shape to take advantage of a tongue-in-groove connection.

The linear connector components 100-400 shown in FIGS. 2A-2D and the tube component 500 shown in FIGS. 3-5 are unitary in that they are made from a single piece of material. In one embodiment, each of these components is formed via press-molding, which provides high quality components having smooth surfaces that reduce turbulence of a traveling fluid, such as molten metal. In one embodiment, each of these components is formed from ceramic, which is a refractory material that can withstand high temperatures, such as that of molten metal. Two identical components can be mated along their respective mating surfaces using adhesive to secure them together to assemble a connector or tube.

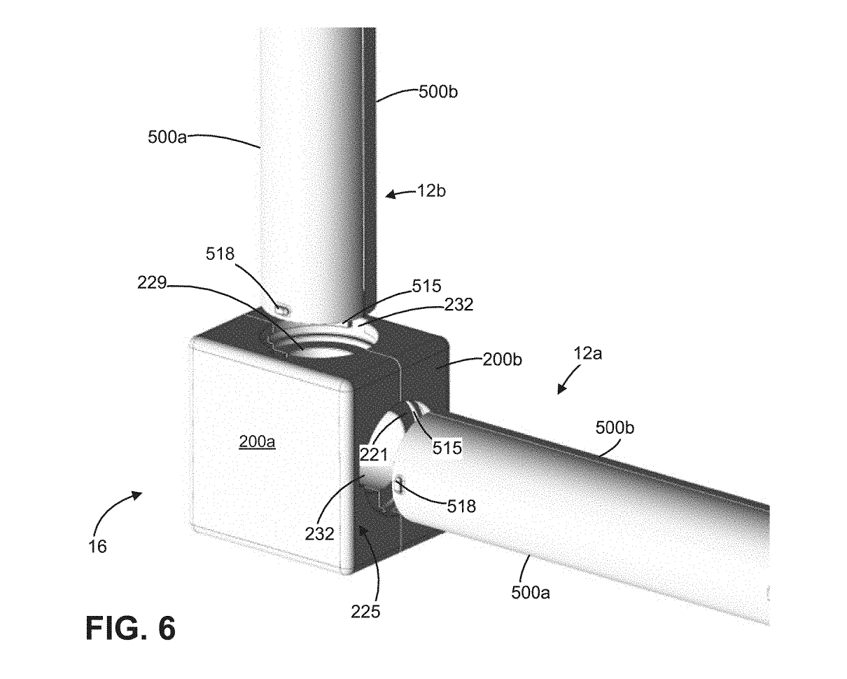

Turning now to FIG. 6, a schematic is shown illustrating two tubes 12a, 12b, which are each constructed from interfacing tube components 500a, 500b made in accordance with the tube component 500 shown in FIGS. 3-5, being inserted into an elbow junction 16, which is constructed from interfacing elbow connector components 200a, 200b made in accordance with the elbow connector component 200 shown in FIG. 2B. When a tube 12 is ready to be inserted into the elbow junction 16, the tube 12 is positioned such that it is coaxially aligned with a tube-fitting socket 225 of the elbow junction 16, the tube-fitting socket 225 being formed by two interfacing tube-fitting recesses 224a, 224c of the interfacing elbow connector components 200a, 200b, and the locking tabs 518 of the tube 12 are aligned with the slots 232 of the tube-fitting socket 225 of the elbow junction 16. The tube 12 is then inserted into the tube-fitting socket 225 until the front end 515 of the tube 12 abuts the enclosed annular rim 221 of the elbow junction 16, the enclosed annular rim 221 being formed by two interfacing semi-annular rims (see rims 220a, 220c of FIG. 2B) of the interfacing elbow connector components 200a, 200b. The locking tabs 518 pass through their corresponding slots 232 and engage the enclosed locking channel 229, which is formed from two interfacing locking channels 218 of the interfacing elbow connector components 200a, 200b. Once the locking tabs 518 have engaged the enclosed locking channel 229, the tube 12 can be twisted or rotated about its axis, allowing the locking tabs 518 to travel circumferentially along the enclosed locking channel surface (not shown) through the enclosed locking channel 229 until they have reached a desired location.

This engagement of the locking tabs 518 with the enclosed locking channel 229 enables the tube 12 to be “locked” in connection with the elbow junction 16, thereby preventing removal of the tube 12 from the elbow junction 16. It also enables the interior conduit (not shown) of the tube 12, which is formed by the interfacing inner surfaces 512 of two interfacing tube components 500a, 500b, to stay in constant communication with the enclosed conduit channel of the elbow junction 16, the enclosed conduit channel being formed by the interfacing conduit channels 222 of the elbow connector components 200a, 200b. This “locked” engagement between the tube 12 and the elbow junction 16 can be enhanced through the use of adhesive between the tube 12 and the elbow junction 16.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A conduit connector comprising:
a first connector component and a second connector component, each of the first connector component and the second connector component comprising:
a base made from a refractory material, said base having a first wall, a second wall opposite said first wall, a third wall extending between said first and second walls, a fourth wall extending between said first and second walls and opposite said third wall, and a mating surface adjacent to said first, second, third, and fourth walls;
a conduit channel extending from said mating surface into said base and defining a conduit channel surface that extends between a first channel rim and a second channel rim;
a tube-fitting recess formed in said base that is coaxially aligned with said conduit channel, said tube fitting recess extending laterally from said first wall to said first channel rim and radially from said mating surface into said base, thereby defining a tube-fitting surface; and
a locking channel formed in said base that is coaxially aligned with said tube-fitting recess, said locking channel extending radially from said tube-fitting surface into said base and defining a locking channel surface, said locking channel being sized and shaped to receive a locking tab from a tube for securing the tube in said tube-fitting recess;
wherein said mating surface of the first connector component is sized and shaped to interface with the mating surface of the second connector component such that when said mating surface of the first connector component is attached to the mating surface of the second conduit connector component, the conduit connector is formed.

2. The conduit connector of claim 1, wherein each of the first and second connector components is unitary.

3. The conduit connector of claim 1, wherein the first connector component further comprises a slot formed in said base that extends laterally from said first wall to said locking channel and depthwise from said tube-fitting surface into said base, said slot being sized and shaped to receive a locking tab from a tube and enable the locking tab to engage with said locking channel.

4. The conduit connector of claim 1, wherein said locking channel is sized and shaped to enable a locking tab from a tube to move circumferentially along said locking channel surface while inhibiting the locking tab from moving transversely away from said locking channel.

5. The conduit connector of claim 1, wherein said mating surface of the first connector component includes at least one protrusion and at least one cavity, said at least one protrusion and said at least one cavity being sized and shaped to interface with a corresponding number of cavities and a corresponding number of protrusions, respectively, of the mating surface of the second connector component.

6. The conduit connector of claim 1, wherein each of the first and second connector components further comprises a second tube-fitting recess formed in said base that is coaxially aligned with said conduit channel, said second tube fitting recess extending laterally from one of said second, third, and fourth walls to said second channel rim and radially from said mating surface into said base, thereby defining a second tube-fitting surface; and a second locking channel formed in said base that is coaxially aligned with said second tube-fitting recess, said second locking channel extending radially from said second tube-fitting surface into said base and defining a second locking channel surface, said second locking channel being sized and shaped to receive a locking tab from a tube for securing the tube in said second tube-fitting recess.

7. The conduit connector of claim 6, wherein the conduit connector is sized and shaped to operate as one of an elbow connector, a tee-junction, and a cross-connector.

8. The conduit connector of claim 1, wherein said refractory material is selected from the group consisting of ceramic and ceramic-composite.

9. The conduit connector of claim 1, wherein the first connector component and the second connector component are identical.

10. The conduit connector of claim 1, wherein the mating surface of the first connector component is attached to the mating surface of the second connector component with an adhesive.

11. A tube comprising:
a first tube component and a second tube component, each of the first tube component and the second tube component comprising:
an elongated semi-cylindrical tube base made from a refractory material, said tube base having a first end, a second end, an outer surface, and an inner surface, said outer surface and inner surface extending between said first end and said second end, said outer surface and said inner surface defining a first mating surface extending between said outer surface and said inner surface on one side of said tube base and a second mating surface extending between said outer surface and said inner surface on an opposing side of said tube base; and
a first locking tab and a second locking tab disposed on said outer surface, said first locking tab being located proximate to said first end and said second locking tab being located proximate to said second end, each of said first and second locking tabs being sized and shaped to interface and engage with a locking channel of a tube-fitting recess of a conduit connector;
wherein said first mating surface and said second mating surface of the first tube component are sized and shaped to interface with the second mating surface and the first mating surface, respectively, of the second tube component such that when said first and second mating surfaces of the first tube component are attached to the second and first mating surfaces of the second tube component, the tube is formed.

12. The tube of claim 11, wherein said first tube component further comprises a plurality of intermediate locking tabs disposed on said outer surface, said plurality of intermediate locking tabs being arranged linearly and located in between said first locking tab and said second locking tab.

13. The tube of claim 12, wherein said first tube component further comprises a plurality of annular grooves disposed on said outer surface that corresponds to said plurality of intermediate locking tabs, each of said plurality of annular grooves being located proximate to a corresponding one of said plurality of intermediate locking tabs, said plurality of annular grooves providing locations for a user to cut and shorten said tube base.

14. The tube of claim 13, wherein each of the plurality of intermediate tabs is a same distance away from its corresponding one of the plurality of annular grooves, said same distance being equal to a distance between said first locking tab and said first end.

15. The tube of claim 11, wherein said first mating surface of said first tube component includes a tongue formation and said second mating surface of said first tube component includes a groove formation.

16. The tube of claim 11, wherein said first tube component is unitary.

17. The tube of claim 11, wherein said refractory material is selected from the group consisting of ceramic and ceramic-composite.

18. The tube of claim 11, wherein the first tube component and the second tube component are identical.

19. The tube of claim 11, wherein said first and second mating surfaces of the first tube component are attached to the second and first mating surfaces, respectively, of the second tube component with an adhesive.

20. A gating system for metal casting comprising:
at least one tube formed from two interfacing refractory tube components, said at least one tube having a first end, a second end, and outer surface and an inner surface, said at least one tube including a tab disposed on said outer surface and located proximate to said first end;
and at least one conduit connector formed from two interfacing refractory conduit connector components, said at least one conduit connector having a base with a first wall and a second wall, a conduit channel that extends through said base from said first wall to said second wall, a tube-fitting recess extending into said base from said first wall to an annular rim, a locking channel formed in said base that is coaxially aligned with said tube-fitting recess and extends radially into said base and defining a locking channel surface, and a slot formed in said base that extends laterally from said first wall to said locking channel.

21. The gating system of claim 20, wherein said slot and said locking channel of said at least one conduit connector are sized and shaped to accommodate said locking tab of said at least one tube such that when said first end of said tube is inserted into said tube-fitting recess of said at least one conduit connector, said locking tab passes through said slot and engages with said locking channel, and when said at least one tube is rotated about its axis, said locking tab is able to travel circumferentially along said locking channel while preventing said at least one tube from being removed from said at least one conduit connector.

22. The gating system of claim 20, wherein each of the interfacing refractory conduit connector components includes a base made from a refractory material, said base having a first wall, a second wall opposite said first wall, a third wall extending between said first and second walls, a fourth wall extending between said first and second walls and opposite said third wall, and a mating surface adjacent to said first, second, third, and fourth walls; a conduit channel extending from said mating surface into said base and defining a conduit channel surface that extends between a first channel rim and a second channel rim; a tube-fitting recess formed in said base that is coaxially aligned with said conduit channel, said tube fitting recess extending laterally from said first wall to said first channel rim and radially from said mating surface into said base, thereby defining a tube-fitting surface; and a locking channel formed in said base that is coaxially aligned with said tube-fitting recess, said locking channel extending radially from said tube-fitting surface into said base and defining a locking channel surface, said locking channel being sized and shaped to receive a locking tab from a tube for securing the tube in said tube-fitting recess.

23. The gating system of claim 20, wherein each of the interfacing refractory tube components includes an elongated semi-cylindrical tube base made from a refractory material, said tube base having a first end, a second end, an outer surface, and an inner surface, said outer surface and inner surface extending between said first end and said second end, said outer surface and said inner surface defining a first mating surface extending between said outer surface and said inner surface on one side of said tube base and a second mating surface extending between said outer surface and said inner surface on an opposing side of said tube base; and a first locking tab and a second locking tab disposed on said outer surface, said first locking tab being located proximate to said first end and said second locking tab being located proximate to said second end, each of said first and second locking tabs being sized and shaped to interface and engage with a locking channel of a tube-fitting recess of a conduit connector.
